(19) United States
(12) Patent Application Publication
(10) Pub. No.: US 2022/0069281 A1
(43) Pub. Date: Mar. 3, 2022

(54) GRAPHENE-INFILTRATED POROUS ANODE ACTIVE MATERIAL PARTICLES FOR RECHARGEABLE LITHIUM BATTERIES

(71) Applicant: Global Graphene Group, Inc., Dayton, OH (US)

(72) Inventors: Kuber Mishra, West Carrollton, OH (US); Song-Hai Chai, Dayton, OH (US); Aruna Zhamu, Springboro, OH (US); Yu-Sheng Su, Dayton, OH (US); Bor Z. Jang, Centerville, OH (US)

(21) Appl. No.: 17/005,915

(22) Filed: Aug. 28, 2020

(51) Int. Cl. H01M 4/133; H01M 4/131; H01M 4/134; H01M 4/36; H01M 4/60; H01M 4/04; H01M 10/0525

(52) U.S. Cl. CPC H01M 4/133; H01M 4/131; H01M 4/134; H01M 4/364; H01M 2004/021; H01M 4/608; H01M 4/0471; H01M 10/0525; H01M 4/366

(57) ABSTRACT

Provided is a porous anode active material particle (or multiple porous particles) for a lithium battery, the particle comprising internal pores, having a pore volume of Vp and pore wall surfaces, and a solid portion having a solid volume Va, wherein the volume ratio Vp/Va is from 0.1/1.0 to 10/1.0 and wherein the pores are infiltrated with a graphene material that partially or fully covers the internal pore wall surfaces. The exterior surfaces of graphene-infiltrated porous particles may also be coated with a graphene materials and optionally further coated or encapsulated with a conducting polymer. Also provided is a method of producing graphene-infiltrated porous anode material particles.

### FIELD

The present disclosure relates generally to the field of lithium batteries and, in particular, to graphene-infiltrated or graphene-impregnated porous primary particles of an anode active material for lithium batteries.

### BACKGROUND

A unit cell or building block of a lithium-ion battery is typically composed of an anode current collector, an anode or negative electrode layer (containing an anode active material responsible for storing lithium therein, a conductive additive, and a resin binder), an electrolyte and porous separator, a cathode or positive electrode layer (containing a cathode active material responsible for storing lithium therein, a conductive additive, and a resin binder), and a separate cathode current collector. The electrolyte is in ionic contact with both the anode active material and the cathode active material. A porous separator is not required if the electrolyte is a solid-state electrolyte.

The binder in the binder layer is used to bond the anode active material (e.g. graphite or Si particles) and a conductive filler (e.g. carbon black or carbon nanotube) together to form an anode layer of structural integrity, and to bond the anode layer to a separate anode current collector, which acts to collect electrons from the anode active material when the battery is discharged. In other words, in the negative electrode (anode) side of the battery, there are typically four different materials involved: an anode active material, a conductive additive, a resin binder (e.g. polyvinylidine fluoride, PVDF, or styrene-butadiene rubber, SBR), and an anode current collector (typically a sheet of Cu foil). Typically the former three materials form a separate, discrete anode layer and the latter one forms another discrete layer.

The most commonly used anode active materials for lithium-ion batteries are natural graphite and synthetic graphite (or artificial graphite) that can be intercalated with lithium and the resulting graphite intercalation compound (GIC) may be expressed as LiₓC₆, where x is typically less than 1. The maximum amount of lithium that can be reversibly intercalated into the interstices between graphene planes of a perfect graphite crystal corresponds to x=1, defining a theoretical specific capacity of 372 mAh/g.

Graphite or carbon anodes can have a long cycle life due to the presence of a protective solid-electrolyte interface layer (SEI), which results from the reaction between lithium and the electrolyte (or between lithium and the anode surface/edge atoms or functional groups) during the first several charge-discharge cycles. The lithium in this reaction comes from some of the lithium ions originally intended for the charge transfer purpose. As the SEI is formed, the lithium ions become part of the inert SEI layer and become irreversible, i.e. these positive ions can no longer be shuttled back and forth between the anode and the cathode during subsequent charges/discharges. Therefore, it is desirable to use a minimum amount of lithium for the formation of an effective SEI layer. In addition to SEI formation, the irreversible capacity loss Qᵢᵣ can also be attributed to graphite exfoliation caused by electrolyte/solvent co-intercalation and other side reactions.

In addition to carbon- or graphite-based anode materials, other inorganic materials that have been evaluated for potential anode applications include metal oxides, metal nitrides, metal sulfides, and the like, and a range of metals, metal alloys, and intermetallic compounds that can accommodate lithium atoms/ions or react with lithium. Among these materials, lithium alloys having a composition formula of LiₐA (A is a metal or semiconductor element, such as Al and Si, and “a” satisfies 0<a≤5) are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li₃Sb (660 mAh/g), Li_{4.4}Pb (569 mAh/g), LiZn (410 mAh/g), and Li₃Bi (385 mAh/g). However, as schematically illustrated in FIG. 2(A), in an anode composed of these high-capacity materials, severe pulverization (fragmentation of the alloy particles) occurs during the charge and discharge cycles due to severe expansion and contraction of the anode active material particles induced by the insertion and extraction of the lithium ions in and out of these particles. The expansion and contraction, and the resulting pulverization, of active material particles, lead to loss of contacts between active material particles and conductive additives and loss of contacts between the anode active material and its current collector. These adverse effects result in a significantly shortened charge-discharge cycle life.

To overcome the problems associated with such mechanical degradation, three technical approaches have been proposed:
(1) reducing the size of the active material particle, presumably for the purpose of reducing the total strain energy that can be stored in a particle, which is a driving force for crack formation in the particle. However, a reduced particle size implies a higher surface area available for potentially reacting with the liquid electrolyte to form a higher amount of SEI. Such a reaction is undesirable since it is a source of irreversible capacity loss.
(2) depositing the electrode active material in a thin film form directly onto a current collector, such as a copper foil. However, such a thin film structure with an extremely small thickness-direction dimension (typically much smaller than 500 nm, often necessarily thinner than 100 nm) implies that only a small amount of active material can be incorporated in an electrode (given the same electrode or current collector surface area), providing a low total lithium storage capacity and low lithium storage capacity per unit electrode surface area (even though the capacity per unit mass can be large). Such a thin film must have a thickness less than 100 nm to be more resistant to cycling-induced cracking, further diminishing the total lithium storage capacity and the lithium storage capacity per unit electrode surface area. Such a thin-film battery has very limited scope of application. A desirable and typical electrode thickness is from 100 μm to 200 μm. These thin-film electrodes (with a thickness of <500 nm or even <100 nm) fall short of the required thickness by three (3) orders of magnitude, not just by a factor of 3.
(3) using a composite composed of small electrode active particles protected by (dispersed in or encapsulated by) a less active or non-active matrix, e.g., carbon-coated Si particles, sol gel graphite-protected Si, metal oxide-coated Si or Sn, and monomer-coated Sn nano particles. Presumably, the protective matrix provides a cushioning effect for particle expansion or shrinkage, and prevents the electrolyte from contacting and reacting with the electrode active material. Examples of high-capacity anode active particles are Si, Sn, and SnO₂. Unfortunately, when an active material particle, such as Si particle, expands (e.g. up to a volume expansion of 380%) during the battery charge step, the protective coating is easily broken due to the mechanical weakness and/o brittleness of the protective coating materials. There has been no high-strength and high-toughness material available that is itself also lithium ion conductive.

It may be further noted that the coating or matrix materials used to protect active particles (such as Si and Sn) are carbon, sol gel graphite, metal oxide, monomer, ceramic, and lithium oxide. These protective materials are all very brittle, weak (of low strength), and/or non-conductive to lithium ions (e.g., ceramic or oxide coating). Ideally, the protective material should meet the following requirements: (a) The protective material must be lithium ion-conducting as well as initially electron-conducting (when the anode electrode is made) and be capable of preventing liquid electrolyte from being in constant contact with the anode active material particles (e.g. Si). (b) The protective material should also have high fracture toughness or high resistance to crack formation to avoid disintegration during cycling. (c) The protective material must be inert (inactive) with respect to the electrolyte, but be a good lithium ion conductor. (d) The protective material must not provide any significant amount of defect sites that irreversibly trap lithium ions. (e) The combined protective material-anode material structure must allow for an adequate amount of free space to accommodate volume expansion of the anode active material particles when lithiated. The prior art protective materials all fall short of these requirements. Hence, it was not surprising to observe that the resulting anode typically shows a reversible specific capacity much lower than expected. In many cases, the first-cycle efficiency is extremely low (mostly lower than 80% and some even lower than 60%). Furthermore, in most cases, the electrode was not capable of operating for a large number of cycles. Additionally, most of these electrodes are not high-rate capable, exhibiting unacceptably low capacity at a high discharge rate.

Due to these and other reasons, most of prior art composite electrodes and electrode active materials have deficiencies in some ways, e.g., in most cases, less than satisfactory reversible capacity, poor cycling stability, high irreversible capacity, ineffectiveness in reducing the internal stress or strain during the lithium ion insertion and extraction steps, and other undesirable side effects.

Complex composite particles of particular interest are a mixture of separate Si and graphite particles dispersed in a carbon matrix; e.g. those prepared by Mao, et al. [“Carbon-coated Silicon Particle Powder as the Anode Material for Lithium Batteries and the Method of Making the Same,” US 2005/0136330 (Jun. 23, 2005)]. Also of interest are carbon matrix-containing complex nano Si (protected by oxide) and graphite particles dispersed therein, and carbon-coated Si particles distributed on a surface of graphite particles Again, these complex composite particles led to a low specific capacity or for up to a small number of cycles only. It appears that carbon by itself is relatively weak and brittle and the presence of micron-sized graphite particles does not improve the mechanical integrity of carbon since graphite particles are themselves relatively weak. Graphite was used in these cases presumably for the purpose of improving the electrical conductivity of the anode material. Furthermore, polymeric carbon, amorphous carbon, or pre-graphitic carbon may have too many lithium-trapping sites that irreversibly capture lithium during the first few cycles, resulting in excessive irreversibility.

In summary, the prior art has not demonstrated a material that has all or most of the properties desired for use as an anode active material in a lithium-ion battery. Thus, there is an urgent and continuing need for a new anode active material that enables a lithium-ion battery to exhibit a high cycle life, high reversible capacity, low irreversible capacity, small particle sizes (for high-rate capacity), and compatibility with commonly used electrolytes. There is also a need for a method of readily or easily producing such a material in large quantities.

Thus, it is a specific object of the present disclosure to meet these needs and address the issues associated the rapid capacity decay of a lithium battery containing a high-capacity anode active material.

### SUMMARY

The present disclosure provides an anode active material particle (or multiple particles) for a lithium battery, the particle (or at least one or each of the multiple particles) comprising internal pores, having a pore volume of Vp and pore wall surfaces, and a solid portion having a solid volume Va, wherein the volume ratio Vp/Va is from 0.1/1.0 to 10/1.0 and wherein the pores are infiltrated with a graphene material that partially or fully covers the internal pore wall surfaces. The pore sizes are typically from 2 nm to 10 μm, more typically and desirably from 10 nm to 2 μm, and most typically and desirably from 50 nm to 500 nm. Preferably these pores are interconnected or are accessible to liquid solution or suspension. The volume ratio Vp/Va is preferably from 0.3/1.0 to 10/1.0 and most preferably from 0.5/1.0 to 5.0/1.0.

In certain preferred embodiments, the external surface of the particle is further covered with a graphene material, typically the same type of graphene material.

The graphene material deposited on the internal wall surfaces or exterior surfaces of the particle typically comprises 1-10 graphene planes stacked together (single-layer or few-layer graphene).

The particle typically has a specific surface area from 5 to 1000 m²/g, more typically from 10 to 500 m²/g, prior to being infiltrated with the graphene material. Preferably, at least half (more preferably >70%) of the internal pore wall surfaces are covered with the graphene material.

In certain embodiments, the anode active material particle is selected from the group consisting of: (a) silicon (Si), germanium (Ge), tin (Sn), phosphorus (P), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, P, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, Nb, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide; (f) prelithiated versions thereof; and (g) combinations thereof.

In some preferred embodiments, the anode active material particle contains a prelithiated Si, prelithiated Ge, prelithiated Sn, prelithiated P, prelithiated SnOₓ, prelithiated SiOₓ, prelithiated iron oxide, prelithiated VO₂, prelithiated Co₃O₄, prelithiated Ni₃O₄, lithium titanate, lithium titanium-niobium oxide (TNO), or a combination thereof, wherein x=1 to 2.

Preferably, the anode active material is in a form of nano particle, nano wire, nano fiber, nano tube, nano sheet, nano belt, nano ribbon, nano disc, nano platelet, or nano horn having a thickness or diameter from 0.5 nm to 100 nm.

The disclosed particle may further comprise a shell or coating of an electronically or lithium ion-conducting polymer that deposits on or encapsulates the graphene-infiltrated particle or the graphene-infiltrated and graphene-coated particle.

The electronically conducting polymer preferably comprises a conjugated polymer (intrinsically electron-conducting polymer) selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof. The conducting polymer may comprise a conducting network of cross-linked polymer chains.

The lithium ion-conducting polymer may comprise an ionically conducting polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, a gel network version thereof, or a combination thereof.

The present disclosure also provides a powder mass of anode particles containing the disclosed anode particle or multiple particles as herein disclosed. Also provided is a battery anode containing the particle or multiple particles herein disclosed. Further disclosed is a battery containing this battery anode. The battery may be a lithium-ion battery, lithium metal secondary battery, lithium-sulfur battery, lithium-air battery, or lithium-selenium battery.

The disclosure further discloses a method of producing multiple particles as disclosed above, the method comprising:
a) Providing multiple porous particles of an anode active material, wherein the particles have internal pores and pore wall surfaces;
b) impregnating the internal pores either with a suspension or solution containing aromatic molecules dispersed or dissolved in a liquid medium or with the aromatic molecules in a liquid form without the liquid medium, wherein the aromatic molecules are selected from petroleum heavy oil or pitch, coal tar pitch, a polynuclear hydrocarbon, a halogenated variant thereof, or a combination thereof and wherein the aromatic molecules, containing a plane of hexagonal carbon atoms or fused aromatic rings, have an initial length or width from 3 nm to 1 μm (preferably from 5 nm to 500 nm);
c) partially or completely removing the liquid medium, if present, allowing the aromatic molecules to stay in the internal pores; and
d) heat treating the aromatic molecules in the internal pores at a first heat treatment temperature selected from 120° C. to 2,500° C. (preferably from 500° C. to 1,500° C. and more preferably from 800° C. to 1,200° C.) for a desired period of time to enable the aromatic molecules to be merged or fused into larger aromatic molecules, larger than the initial length or width, to form a graphene material having graphene planes on the pore wall surfaces. Typically, higher heat treatment temperatures promote the formation of a graphene material, as opposed to the formation of an amorphous carbon phase.

The method may further comprise a step of heat-treating the particles at a second temperature higher than the first temperature.

It may be noted that no prior art method has been able to infiltrate or impregnate a graphene material into internal pore surfaces of porous anode particles, such as Si, SiOₓ, SnO₂, just to name a few. For instance, once graphene or graphene oxide sheets are made, it becomes practically impossible to implement these sheets of graphene material into the internal pores of an anode material particle.

The method may be conducted in such a manner that step (b) further comprises depositing the aromatic molecules on the external surfaces of the particles and step (d) comprises heat treating the aromatic molecules on the external surface at the first temperature so that the aromatic molecules are merged or fused into larger aromatic molecules to form graphene planes deposited on the external surface. In these situations, both the internal pore wall surfaces and external surfaces of the anode material particles are deposited with a graphene material.

In the disclosed method, the polynuclear hydrocarbon is preferably selected from naphthalene, anthracene, phenanthrene, tetracene, chrysene, triphenylene, pyrene, pentacene, benzo-pyrene, corannulene, benzo-perylene, coronene, ovalene, benzo-fluorene, perylene, porphyrine, phthalocycnine, a derivative thereof having a substituent on a ring structure thereof, a chemical derivative thereof, or a combination thereof.

In the method, the liquid medium may contain a non-aqueous solvent selected from polyethylene glycol, ethylene glycol, propylene glycol, an alcohol, a sugar alcohol, a polyglycerol, a glycol ether, an amine based solvent, an amide based solvent, an alkylene carbonate, an organic acid, or an inorganic acid.

In certain embodiments, the suspension or solution in step (a) further comprises a catalyst that contains a transition metal selected from Ti, V, Cr, Mn, Fe, Co, Ni, Cu, Zn, Zr, Nb, Mo, Ru, Pd, Ag, Cd, Pt, Au, a combination thereof, or wherein the catalyst contains a chemical species selected from PdCl₂, FeCl₃, FeBr₃, FeF₃, NiBr₂, NiI₂, Cs₂CO₃, CsF, CsCl, CsBr, CH₂CL₂, or a combination thereof. Alternatively, the catalyst may be pre-deposited into the internal pores prior to step (a). The presence of such a catalytic chemical species promotes the formation of a graphene material by significantly lowering the required heat treatment temperature.

Alternatively, prior to step (a), the internal pores of the particles may be infiltrated, impregnated or deposited with a catalyst that contains a transition metal selected from Ti, V, Cr, Mn, Fe, Co, Ni, Cu, Zn, Zr, Nb, Mo, Ru, Pd, Ag, Cd, Pt, Au or a chemical species selected from PdCl₂, FeCl₃, FeBr₃, FeF₃, NiBr₂, NiI₂, Cs₂CO₃, CsF, CsCl, CsBr, CH₂CL₂, or a combination thereof.

In certain embodiments, the method further comprises, after step (d), a step of incorporating the multiple anode particles into a battery anode electrode.

In some embodiments, the particles of anode active material contain pre-lithiated particles having 0.1% to 54.7% by weight of lithium ions preloaded into said particles prior to step (a) of mixing.

The method may further comprise a step of depositing an electron-conducting or ion-conducting material on the particles after step (d). The disclosed method may further comprise a step of coating the multiple particles with a conducting polymer after step (d).

In the method, the particles of anode active material are selected from the group consisting of: (a) silicon (Si), germanium (Ge), tin (Sn), phosphorus (P), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, P, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, Nb, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide; (f) prelithiated versions thereof; and (g) combinations thereof. The anode active material particles are preferably in a form of flakes, beads, pellets, spheres, wires, fibers, filaments, discs, ribbons, or rods, having a diameter or thickness from 2 nm to 20 μm.

By definition, graphene or graphene sheets contain from 1 to 10 graphene planes stacked together via van der Waals forces; including single-layer graphene (containing only one graphene plane or hexagonal carbon atom plane) and few layer graphene (containing 2-10 graphene planes).

### BRIEF DESCRIPTION OF THE DRAWINGS

FIG. 1 Schematic of a procedure for depositing a graphene material on internal pore wall surfaces of a porous anode active material particle.

FIG. 2(A) Schematic illustrating the notion that expansion of Si particles, upon lithium intercalation during charging of a prior art lithium-ion battery, can lead to pulverization of Si particles, interruption of the conductive paths formed by the conductive additive, and loss of contact with the current collector;

FIG. 2(B) illustrates the issues associated with prior art anode active material; for instance, a non-lithiated Si particle encapsulated by a protective shell (e.g. carbon shell) in a core-shell structure inevitably leads to breakage of the shell and that a pre-lithiated Si particle encapsulated with a protective layer leads to poor contact between the contracted Si particle and the rigid protective shell during battery discharge.

FIG. 3 SEM image of a porous primary Si particle.

FIG. 4 The charge-discharge cycling behaviors of 2 lithium cells featuring porous Si particle-based anodes: one cell containing graphene-infiltrated particles (prepared by heat-treating naphthalene at 950° C.) and the other cell containing amorphous carbon-infiltrated porous Si particles (prepared by heat-treating naphthalene at 650° C.).

FIG. 5 The specific capacity values of 2 lithium-ion cells having SnO₂ particles as the anode active material: one cell featuring conducting polyaniline (PANi)-encapsulated graphene-infiltrated porous SnO₂ particles; second cell having an anode featuring PANi-encapsulated porous SnO₂ particles but without graphene infiltration.

FIG. 6 Cycle life of lithium-ion cell containing graphene-infiltrated porous Si particles, plotted as a function of the pore-to-solid volume ratio in the particles.

FIG. 7 A cross-sectional view of an anode active material particle containing internal pores, graphene material in the pores, and an optional encapsulating coating.

### DETAILED DESCRIPTION OF PREFERRED EMBODIMENTS

A lithium-ion battery cell is typically composed of an anode current collector (e.g. Cu foil), an anode or negative electrode active material layer (i.e. anode layer typically containing particles of an anode active material, conductive additive, and binder), a porous separator and/or an electrolyte component, a cathode or positive electrode active material layer (containing a cathode active material, conductive additive, and resin binder), and a cathode current collector (e.g. Al foil). More specifically, the anode layer is composed of particles of an anode active material (e.g. graphite, Sn, SnO₂, or Si), a conductive additive (e.g. carbon black particles), and a resin binder (e.g. SBR or PVDF). This anode layer is typically 50-300 μm thick (more typically 100-200 μm) to give rise to a sufficient amount of current per unit electrode area.

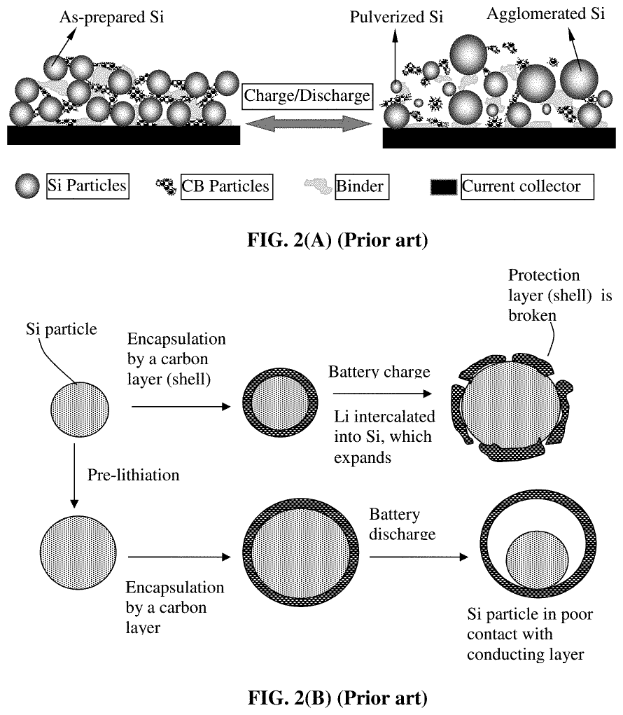

In order to obtain a higher energy density cell, the anode can be designed to contain higher-capacity anode active materials having a composition formula of LiₐA (A is a metal or semiconductor element, such as Al and Si, and “a” satisfies 0<a≤5). These materials are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li₃Sb (660 mAh/g), Li_{4.4}Pb (569 mAh/g), LiZn (410 mAh/g), and Li₃Bi (385 mAh/g). However, as discussed in the Background section, there are several problems associated with the implementation of these high-capacity anode active materials:
1) As schematically illustrated in FIG. 2(A), in an anode composed of these high-capacity materials, severe pulverization (fragmentation of the alloy particles) occurs during the charge and discharge cycles due to severe expansion and contraction of the anode active material particles induced by the insertion and extraction of the lithium ions in and out of these particles. The expansion and contraction, and the resulting pulverization, of active material particles, lead to loss of contacts between active material particles and conductive additives and loss of contacts between the anode active material and its current collector. These adverse effects result in a significantly shortened charge-discharge cycle life.
2) The approach of using a composite composed of small electrode active particles protected by (dispersed in or encapsulated by) a less active or non-active matrix, e.g., carbon-coated Si particles, sol gel graphite-protected Si, metal oxide-coated Si or Sn, and monomer-coated Sn nano particles, has failed to overcome the capacity decay problem. Presumably, the protective matrix provides a cushioning effect for particle expansion or shrinkage, and prevents the electrolyte from contacting and reacting with the electrode active material. Unfortunately, when an active material particle, such as Si particle, expands (e.g. up to a volume expansion of 380%) during the battery charge step, the protective coating is easily broken due to the mechanical weakness and/or brittleness of the protective coating materials. There has been no high-strength and high-toughness material available that is itself also lithium ion conductive.
3) The approach of using a core-shell structure (e.g. Si nano particle encapsulated in a carbon or SiO₂ shell) also has not solved the capacity decay issue. As illustrated in upper portion of FIG. 2(B), a non-lithiated Si particle can be encapsulated by a carbon shell to form a core-shell structure (Si core and carbon or SiO₂ shell in this example). As the lithium-ion battery is charged, the anode active material (carbon- or SiO₂-encapsulated Si particle) is intercalated with lithium ions and, hence, the Si particle expands. Due to the brittleness of the encapsulating shell (carbon), the shell is broken into segments, exposing the underlying Si to electrolyte and subjecting the Si to undesirable reactions with electrolyte during repeated charges/discharges of the battery. These reactions continue to consume the electrolyte and reduce the cell's ability to store lithium ions.
4) Referring to the lower portion of FIG. 2(B), wherein the Si particle has been pre-lithiated with lithium ions; i.e. has been pre-expanded in volume. When a layer of carbon (as an example of a protective material) is encapsulated around the pre-lithiated Si particle, another core-shell structure is formed. However, when the battery is discharged and lithium ions are released (de-intercalated) from the Si particle, the Si particle contracts, leaving behind a large gap between the protective shell and the Si particle. Such a configuration is not conducive to lithium intercalation of the Si particle during the subsequent battery charge cycle due to the gap and the poor contact of Si particle with the protective shell (through which lithium ions can diffuse). This would significantly curtail the lithium storage capacity of the Si particle particularly under high charge rate conditions.

In other words, there are several conflicting factors that must be considered concurrently when it comes to the design and selection of an anode active material in terms of material type, shape, size, porosity, and electrode layer thickness. Thus far, there has been no effective solution offered by any prior art teaching to these conflicting problems. We have solved these challenging issues that have troubled battery designers and electrochemists alike for more than 30 years by developing the approach of graphene-infiltrated highly porous particles of an anode active material.

In certain embodiments, the present disclosure provides an anode active material particle (or multiple particles) for a lithium battery as is generally shown in FIG. 7, the particle (or at least one or each of the multiple particles) comprising internal pores, having a pore volume of Vp and pore wall surfaces, and a solid portion having a solid volume Va, wherein the volume ratio Vp/Va is from 0.1/1.0 to 10/1.0 and wherein the pores are infiltrated with a graphene material that partially or fully covers the internal pore wall surfaces. The pore sizes are typically from 2 nm to 10 μm, more typically and desirably from 10 nm to 2 μm, and most typically and desirably from 50 nm to 500 nm. Preferably these pores are interconnected or are accessible to liquid solution or suspension. The volume ratio Vp/Va is preferably from 0.3/1.0 to 10/1.0 and most preferably from 0.5/1.0 to 5.0/1.0.

In certain preferred embodiments, the external surface of the particle is further covered with a graphene material, typically the same type of graphene material. The graphene material deposited on the internal wall surfaces or exterior surfaces of the particle typically comprises 1-10 graphene planes stacked together.

The particle typically has a specific surface area from 5 to 1000 m²/g (more typically from 10 to 500 m²/g, and further more typically and desirably from 20 to 100 m²/g) prior to being infiltrated with the graphene material. Preferably, at least half (more preferably >70%) of the internal pore wall surfaces are covered with the graphene material.

Preferably, the primary particles of an anode active material contain a high-capacity anode active material having a specific lithium storage capacity greater than 372 mAh/g (which is the theoretical capacity of graphite).

The porous primary anode active material particles have internal pores. The production methods of porous solid particles are well-known in the art. For instance, the production of porous Si particles may be accomplished by etching particles of a Si—Al alloy using HCl solution (to remove the Al element leaving behind pores) or by etching particles of a Si—SiO₂ mixture using HF solution (by removing SiO₂ to create pores).

Porous SnO₂ nano particles may be synthesized by a modified procedure described by Gurunathan et al [P. Gurunathan, P. M. Ette and K. Ramesha, ACS Appl. Mater. Inter., 6 (2014) 16556-16564]. In a typical synthesis procedure, 8.00 g of SnCl₁.26H₂O, 5.20 g of resorcinol and 16.0 mL of 37% formaldehyde solution were mixed in 160 mL of H₂O for about 30 minutes. Subsequently, the solution is sealed in a 250 mL round-bottom flask and kept in water bath at 80° C. for 4 hours. The resulting red gel is dried at 80° C. in an oven and calcined at 700° C. for 4 hours in N₂ and air atmosphere in sequence. Finally, the obtained white SnO₂ may be mechanically ground into finer powder for 30-60 minutes in mortar.

All types of porous anode active material particles may be produced by depositing the anode active material onto surfaces or into pores of a sacrificial material structure, followed by removing the sacrificial material. Such a deposition can be conducted using CVD, plasma-enhanced CVD, physical vapor deposition, sputtering, solution deposition, melt impregnation, chemical reaction deposition, etc.

This amount of pore volume inside the particle provides empty space to accommodate the volume expansion of the anode active material so that the external surface (and the solid-electrolyte interphase or SEI formed thereon) would not significantly expand when the lithium battery is charged. Preferably, the particle does not increase its volume by more than 20%, further preferably less than 10% and most preferably by approximately 0% when the lithium battery is charged. This can be accomplished by making the ratio of total pore volume-to-solid anode particle volume to be in the range from 0.3/1.0 to 4.0/1.0. Such a constrained volume expansion of the particle would not only reduce or eliminate the volume expansion of the anode electrode but also reduce or eliminate the issue of repeated formation and destruction of a solid-electrolyte interface/interphase (SEI). We have discovered that this strategy surprisingly results in significantly reduced battery capacity decay rate and dramatically increased charge/discharge cycle numbers. These results are unexpected and highly significant with great utility value.

Carbon materials can assume an essentially amorphous structure (glassy carbon), a highly organized crystal (graphite), or a whole range of intermediate structures that are characterized in that various proportions and sizes of graphite crystallites and defects are dispersed in an amorphous matrix. Typically, a graphite crystallite is composed of a number of graphene sheets or basal planes that are bonded together through van der Waals forces in the c-axis direction, the direction perpendicular to the basal plane. These graphite crystallites are typically micron- or nanometer-sized. The graphite crystallites are dispersed in or connected by crystal defects or an amorphous phase in a graphite particle, which can be a graphite flake, carbon/graphite fiber segment, carbon/graphite whisker, or carbon/graphite nano-fiber. In other words, graphene planes (hexagonal lattice structure of carbon atoms) constitute a significant portion of a graphite particle.

The processes for production of exfoliated graphite worms and subsequently separated graphene sheets typically involve immersing natural or artificial graphite powder in a mixture of concentrated sulfuric acid, nitric acid, and an oxidizer, such as potassium permanganate or sodium perchlorate. It typically requires 5-120 hours to complete the chemical intercalation/oxidation reaction. Once the reaction is completed, the slurry is subjected to repeated steps of rinsing and washing with water and then subjected to drying treatments to remove water.

The dried powder is commonly referred to as graphite intercalation compound (GIC) or graphite oxide (GO). This GO/GIC is then subjected to a thermal shock treatment, which is most typically accomplished by exposing the GIC/GO to a furnace pre-set at a temperature of typically 800-1200° C. (more typically 950-1050° C.). This thermal shock operation typically leads to the formation of exfoliated graphite worms. A graphite worm is a bulk graphite entity that is composed of interconnected graphite flakes having large spaces between flakes. The flakes are typically composed of >100 graphene planes (>35 nm in thickness) and they are interconnected together to form a fluffy, worm-like morphology. When subjected to low-intensity mechanical shearing, graphite worms can be broken up into separated/isolated expanded graphite flakes. High-intensity mechanical shearing can lead to the formation of graphene sheets instead.

Separated graphene sheets (e.g. reduced graphene oxide, RGO) may also be prepared by subjecting the GO/water slurry or suspension to mechanical shearing (e.g. ultrasonication), followed by drying and thermal reduction of graphene oxide sheets. Pristine graphene sheets are typically obtained by using the so-called liquid phase exfoliation or direct ultrasonication.

Once graphene sheets are obtained, it becomes practically impossible to impregnate these graphene sheets into internal pores of an anode active material particle. The present disclosure provides a surprisingly effective method of introducing graphene into the internal pores and external surfaces of one or multiple porous particles of an anode active material.

The anode active material particle may be selected from the group consisting of: (a) silicon (Si), germanium (Ge), tin (Sn), phosphorus (P), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, P, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, Nb, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide; (f) prelithiated versions thereof; and (g) combinations thereof.

The anode active material particle preferably contains a prelithiated Si, prelithiated Ge, prelithiated Sn, prelithiated P, prelithiated SnOₓ, prelithiated SiOₓ, prelithiated iron oxide, prelithiated VO₂, prelithiated Co₃O₄, prelithiated Ni₃O₄, lithium titanate, lithium titanium-niobium oxide (TNO), or a combination thereof, wherein x=1 to 2. Preferably, the anode active material is in a form of nano particle, nano wire, nano fiber, nano tube, nano sheet, nano belt, nano ribbon, nano disc, nano platelet, or nano horn having a thickness or diameter from 0.5 nm to 100 nm.

As shown in FIG. 7, the disclosed particle may optionally further comprise a (full or partial) shell or coating of an electrically or lithium ion-conducting polymer that deposits on or encapsulates the graphene-infiltrated particle or the graphene-infiltrated and graphene-coated particle.

The conducting polymer preferably comprises a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof. The conducting polymer may comprise a conducting network of cross-linked polymer chains.

The present disclosure also provides a powder mass of anode particles containing the disclosed anode particle or multiple particles as herein disclosed. Also provided is a battery anode containing the particle or multiple particles herein disclosed. Further disclosed is a battery containing this battery anode. The battery may be a lithium-ion battery, lithium metal secondary battery, lithium-sulfur battery, lithium-air battery, or lithium-selenium battery.

The disclosed graphene-infiltrated porous anode particles have the following special characteristics or advantages that are highly surprising and desirable:
(a) The internal pores of a particle can accommodate the volume expansion of the particle inwardly, avoiding the particle volume to expand outwardly that otherwise would cause repeated formation and destruction of solid-electrolyte interphase (SEI) and thus continued consumption of electrolyte and lithium ions.
(b) The presence of the graphene material in the internal pores (typically formed in situ from aromatic molecules), along with the graphene material deposited on the external surfaces of the particle and/or a conductive additive in an anode electrode, enables the formation of a 3D network of electron-conducting pathways between primary anode particles (e.g. Si and SiOₓ particles, 0<x<2.0).
(c) The graphene material that covers the internal pore wall surfaces can prevent direct contact between liquid electrolyte and the internal surfaces of the porous anode material particle, preventing formation of SEI on these internal surfaces. These surfaces typically have a high specific surface area which, if not protected or covered, could form a large amount of SEI, thereby consuming large quantities of electrolyte and lithium ions.
(d) This approach surprisingly results in significantly increased first-cycle efficiency and the Coulombic efficiencies of subsequent cycles, reduced battery capacity decay rate and dramatically increased charge/discharge cycle numbers. These results are unexpected and highly significant with great utility value

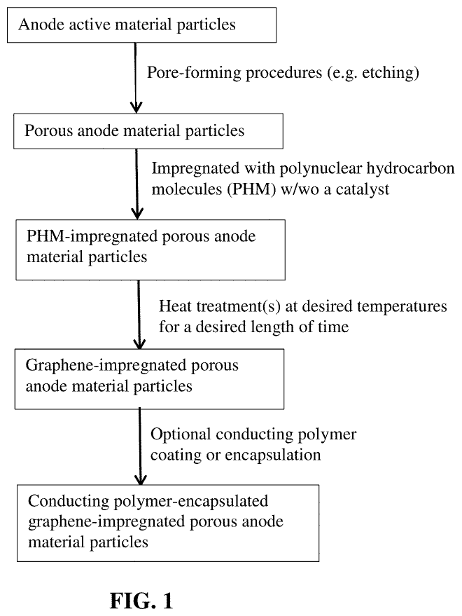

As illustrated in FIG. 1, the disclosure further discloses a method of producing multiple particles as disclosed above, the method comprising: (a) Providing multiple porous particles of an anode active material, wherein the particles have internal pores and pore wall surfaces; (b) impregnating the internal pores either with a suspension or solution containing aromatic molecules dispersed or dissolved in a liquid medium or with the aromatic molecules in a liquid form without the liquid medium, wherein the aromatic molecules are selected from petroleum heavy oil or pitch, coal tar pitch, a polynuclear hydrocarbon, a halogenated variant thereof, or a combination thereof and wherein the aromatic molecules, containing a plane of hexagonal carbon atoms or fused aromatic rings, have an initial length or width from 3 nm to 1 μm (preferably from 5 nm to 500 nm); (c) partially or completely removing the liquid medium, if present, allowing the aromatic molecules to stay in the internal pores; and (d) heat treating the aromatic molecules in the internal pores at a first heat treatment temperature selected from 120° C. to 2,500° C. (preferably from 500° C. to 1,500° C. and more preferably from 800° C. to 1,200° C. if without the presence of a catalyst) for a desired period of time to enable the aromatic molecules to be merged or fused into larger aromatic molecules, larger than the initial length or width, to form a graphene material having graphene planes on the pore wall surfaces. Typically, higher heat treatment temperatures promote the formation of a graphene material, as opposed to the formation of an amorphous carbon phase.

The method may further comprise a step of heat-treating the particles at a second temperature higher than the first temperature.

It may be noted that no prior art method has been able to infiltrate or impregnate a graphene material into internal pore surfaces of porous anode particles, such as Si, SiOₓ, SnO₂, just to name a few. For instance, once graphene or graphene oxide sheets are made, it becomes practically impossible to implement these sheets of graphene material into the internal pores of an anode material particle.

The method may be conducted in such a manner that step (b) further comprises depositing the aromatic molecules on the external surfaces of the particles and step (d) comprises heat treating the aromatic molecules on the external surface at the first temperature so that the aromatic molecules are merged or fused into larger aromatic molecules to form graphene planes deposited on the external surface. In these situations, both the internal pore wall surfaces and external surfaces of the anode material particles are deposited with a graphene material.

Polynuclear hydrocarbons (also referred to as polycyclic aromatic hydrocarbons, PAHs, polyaromatic hydrocarbons, or polynuclear aromatic hydrocarbons) are hydrocarbons (organic compounds containing mostly carbon and hydrogen) that are essentially composed of multiple aromatic rings fused together (fused organic rings in which the electrons are delocalized). Prior to the first heat treatment, the starting PAHs contain mostly or substantially all fused rings (e.g. chlorinated anthracene). Although not preferred, the starting aromatic materials in the instant process may be selected from those containing isolated benzene rings that are connected by a linear chain or bond (e.g. 2′-chloro-1,1′:4′,1″-terphenyl). Herein, PAHs include those having further branching substituents on these ring structures. The simplest of such chemicals are naphthalene, having two aromatic rings, and the three-ring compounds anthracene and phenanthrene. Briefly, examples of PAHs are halogenated and non-halogenated versions of naphthalene, anthracene, phenanthrene, tetracene, chrysene, triphenylene, pyrene, pentacene, benzo-pyrene, corannulene, benzo-perylene, coronene, ovalene, and benzo-fluorene. PAHs of interest here typically have from 2 to 20 aromatic rings (approximately 10 to 60 carbon atoms) fused together, more typically from 2 to 10 rings (approximately 10 to 32 carbon atoms). However, they can have a larger number of fused rings or fused polycyclic aromatics.

Petroleum- or coal-derived pitch is a mixture of larger polynuclear hydrocarbons with an average molecular weight of approximately 200 amu (approximately 180-200 carbon atoms or 60-66 rings). Each pitch product is a mixture of many different types and sizes of polynuclear hydrocarbons. There are also a variety of impurities (1-10% by weight) in such pitch materials. In contrast, those PAHs mentioned above are substantially impurity-free.

In the disclosed method, the polynuclear hydrocarbon is preferably selected from naphthalene, anthracene, phenanthrene, tetracene, chrysene, triphenylene, pyrene, pentacene, benzo-pyrene, corannulene, benzo-perylene, coronene, ovalene, benzo-fluorene, perylene, porphyrine, phthalocycnine, a derivative thereof having a substituent on a ring structure thereof, a chemical derivative thereof, or a combination thereof.

Aromatic graphene molecules may contain halogen selected from F, Cl, Br, I, or a combination thereof. The halogen atoms in the halogenated aromatic molecules are preferably attached to a carbon atom at the edge of a fused benzene ring-type structure. The halogen atoms are preferably not part of the fused benzene ring structure.

Preferably, the polynuclear hydrocarbon may contain halogenated polynuclear hydrocarbon selected from halogenated versions of naphthalene, anthracene, phenanthrene, tetracene, chrysene, triphenylene, pyrene, pentacene, benzo-pyrene, corannulene, benzo-perylene, coronene, ovalene, benzo-fluorene, a derivative thereof having a substituent on a ring structure thereof, a chemical derivative thereof, or a combination thereof.

The halogenation of aromatic molecules is well known in the art. For instance, halogenation of anthracene may be accomplished by following the approaches proposed by Duan, et a. [Duan, Turk, Speigle, Corbin, Masnovi and Baker, Halogenations of Anthracenes and Dibenz[a,c]anthracene with N-Bromosuccinimide and N-Chlorosuccinimide, The Journal of Organic Chemistry, 2000 65 (10), pp 3005-3009]. For instance,

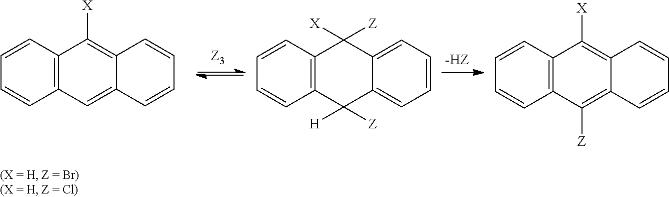

The aromatic molecules, prior to step (a) or (b), may be preferably attached with some desired functional groups that facilitate or promote edge-to-edge chemical merging or linking between molecules during step (c) of heat-treating. In some embodiments, aromatic molecules recited in step (a) are chemically functionalized with a functional group selected from —OH, —COOH, —NH₂, —C═O, or a combination thereof.

In some embodiments, the functional group attached to the aromatic molecules prior to step (a) or (b) may be selected from alkyl or aryl silane, alkyl or aralkyl group, hydroxyl group, carboxyl group, amine group, sulfonate group (—SO₃H), aldehydic group, quinoidal, fluorocarbon, or a combination thereof.

In certain embodiments, the functional group attached to the aromatic molecules prior to step (a) or (b) may contain an azide compound selected from the group consisting of 2-Azidoethanol, 3-Azidopropan-1-amine, 4-(2-Azidoethoxy)-4-oxobutanoic acid, 2-Azidoethyl-2-bromo-2-methylpropanoate, chlorocarbonate, azidocarbonate, dichlorocarbene, carbene, aryne, nitrene, (R−)-oxycarbonyl nitrenes, where R=any one of the following groups,

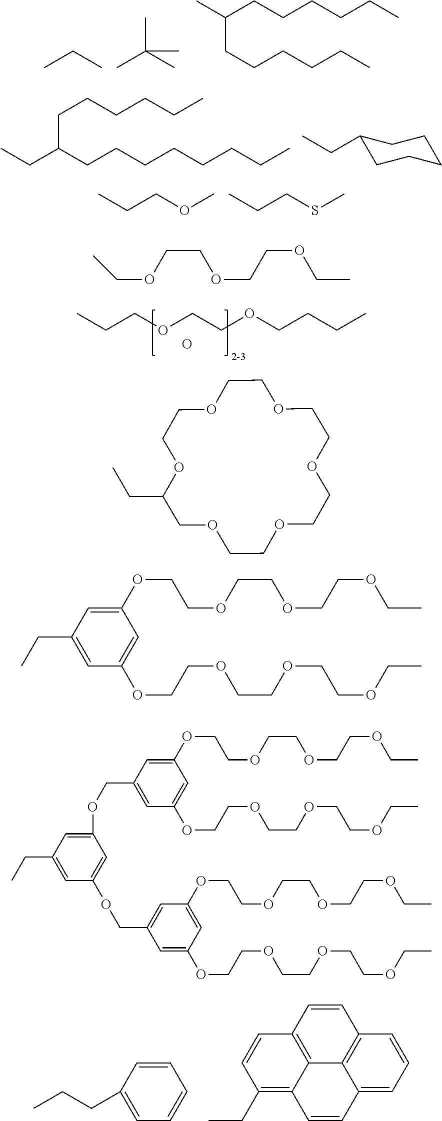

and combinations thereof.

In certain embodiments, the functional group attached to the aromatic molecules prior to step (a) or (b) may contain an oxygenated group selected from the group consisting of hydroxyl, peroxide, ether, keto, and aldehyde. In certain embodiments, the functionalizing agent contains a functional group selected from the group consisting of SO₃H, COOH, NH₂, OH, R′CHOH, CHO, CN, COCl, halide, COSH, SH, COOR′, SR′, SiR′₃, Si(—OR′—)_{y}R′₃-y, Si(—O—SiR′₂—)OR′, R″, Li, AiR′₂, Hg—X, TlZ₂ and Mg—X; wherein y is an integer equal to or less than 3, R′ is hydrogen, alkyl, aryl, cycloalkyl, or aralkyl, cycloaryl, or poly(alkylether), R″ is fluoroalkyl, fluoroaryl, fluorocycloalkyl, fluoroaralkyl or cycloaryl, X is halide, and Z is carboxylate or trifluoroacetate, and combinations thereof.

In some embodiments, the functional group attached to the aromatic molecules prior to step (a) or (b) may be selected from the group consisting of amidoamines, polyamides, aliphatic amines, modified aliphatic amines, cycloaliphatic amines, aromatic amines, anhydrides, ketimines, diethylenetriamine (DETA), triethylene-tetramine (TETA), tetraethylene-pentamine (TEPA), polyethylene polyamine, polyamine epoxy adduct, phenolic hardener, non-brominated curing agent, non-amine curatives, and combinations thereof. The functionalizing agent may contain an acrylonitrile chain, polyfurfuryl alcohol, phenolic resin, or a combination thereof.

In some embodiments, the functional group is selected from OY, NHY, O═C—OY, P═C—NR′Y, O═C—SY, O═C—Y, —CR′1-OY, N′Y or C′Y, and Y is a functional group of a protein, a peptide, an amino acid, an enzyme, an antibody, a nucleotide, an oligonucleotide, an antigen, or an enzyme substrate, enzyme inhibitor or the transition state analog of an enzyme substrate or is selected from R′—OH, R′—NR′₂, R′SH, R′CHO, R′CN, R′X, R′N⁺(R′)₃X⁻, R′SiR′₃, R′Si(—OR′—)_{y}R′_{3-y}, R′Si(—O—SiR′₂—)OR′, R′—R″, R′—N—CO, (C₂H₄O—)_{w}H, (—C₃H₆O—)_{w}H, (—C₂H₄O)_{w}—R′, (C₃H₆O)_{w}—R′, R′, and w is an integer greater than one and less than 200.

In the method, the liquid medium may contain a non-aqueous solvent selected from polyethylene glycol, ethylene glycol, propylene glycol, an alcohol, a sugar alcohol, a polyglycerol, a glycol ether, an amine based solvent, an amide based solvent, an alkylene carbonate, an organic acid, or an inorganic acid.

In certain embodiments, the suspension in step (a) may contain a catalyst that promotes the chemical linking between aromatic molecules and facilitates the formation of graphene domains or graphite single crystals during the heat treatment step. Thus, the suspension or solution in step (a) may further comprise a catalyst that contains a transition metal selected from Ti, V, Cr, Mn, Fe, Co, Ni, Cu, Zn, Zr, Nb, Mo, Ru, Pd, Ag, Cd, Pt, Au, a combination thereof, or wherein the catalyst contains a chemical species selected from PdCl₂, FeCl₃, FeBr₃, FeF₃, NiBr₂, NiI₂, Cs₂CO₃, CsF, CsCl, CsBr, CH₂CL₂, or a combination thereof. Alternatively, the catalyst may be pre-deposited into the internal pores prior to step (a). The presence of such a catalytic chemical species promotes the formation of a graphene material by significantly lowering the required heat treatment temperature.

Alternatively, prior to step (a), the internal pores of the particles may be infiltrated, impregnated or deposited with a catalyst that contains a transition metal selected from Ti, V, Cr, Mn, Fe, Co, Ni, Cu, Zn, Zr, Nb, Mo, Ru, Pd, Ag, Cd, Pt, Au or a chemical species selected from PdCl₂, FeCl₃, FeBr₃, FeF₃, NiBr₂, NiI₂, Cs₂CO₃, CsF, CsCl, CsBr, CH₂CL₂, or a combination thereof.

Structural changes of the aromatic molecules during heat treatments may be investigated by using the scanning electron microscope (SEM), transmission electron microscope (TEM), and Raman spectrometer, particularly for the determination of graphene domains and number of graphene planes in a graphene material deposited in the internal pores or on the surfaces of anode material particles. The changes in inter-planar spacings (d₀₀₂) and apparent crystallite sizes (L_{c}) may be studied by X-ray diffraction. Electron probe and electron diffraction may also be used in determining structures present. Without the assistance of a catalyst, the formation of graphene domains or phases typically occurs at 750-1,500° C., depending on the type of the polycyclic aromatic molecules used. This graphene formation temperature may be reduced by from 100 to 600 degrees (in the Celsius scale). This is particularly desirable and surprising.

After a powder mass of multiple porous particles containing graphene-infiltrated internal pores are produced, these particles may be further coated with or encapsulated by an electrically conducting polymer or a lithium ion-conducting polymer.

Preferably, the electrically conducting polymer comprises a gel network of conjugated polymer chains selected from Polyacetylene, Polythiophene, Poly(3-alkylthiophenes), Polypyrrole, Polyaniline, Poly(isothianaphthene), Poly(3,4-ethylenedioxythiophene) (PEDOT), alkoxy-substituted Poly(p-phenylene vinylene), Poly(2,5-bis(cholestanoxy) phenylene vinylene), Poly(p-phenylene vinylene), Poly(2,5-dialkoxy) paraphenylene vinylene, Poly[(1,4-phenylene-1,2-diphenylvinylene)], Poly(3′,7′-dimethyloctyloxy phenylene vinylene), Polyparaphenylene, Polyparaphenylene, Polyparaphenylene sulphide, Polyheptadiyne, Poly(3-hexylthiophene), Poly(3-octylthiophene), Poly(3-cyclohexylthiophene), Poly(3-methyl-4-cyclohexylthiophene), Poly(2,5-dialkoxy-1,4-phenyleneethynylene), Poly(2-decyloxy-1,4-phenylene), Poly(9,9-dioctylfluorene), Polyquinoline, a derivative thereof, a copolymer thereof, a sulfonated version thereof, or a combination thereof.

Further preferably, the conducting polymer gel network comprises a polyaniline network, polypyrrole network, or polythiophene network. Such a conducting polymer network is typically a lightly crosslinked polymer, capable of elastically deforming to a significant extent (typically at least >10% and can be higher than 50% under tension). Elastic deformation means that the deformation is reversible.

lithium ion-conducting material comprises an ionically conducting polymer gel network comprising a polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof.

There are three broad categories of micro-encapsulation methods that can be implemented to produce conducting polymer network embedded or encapsulated anode particles (the micro-droplets): physical methods, physico-chemical methods, and chemical methods. The physical methods include pan-coating, air-suspension coating, centrifugal extrusion, vibration nozzle, and spray-drying methods. The physico-chemical methods include ionotropic gelation and coacervation-phase separation methods. The chemical methods include interfacial polycondensation, interfacial cross-linking, in-situ polymerization, and matrix polymerization.

Pan-coating method: The pan coating process involves tumbling the graphene-infiltrated porous anode active material particles in a pan or a similar device while the matrix or encapsulating material (e.g. monomer/oligomer liquid or polymer/solvent solution) is applied slowly until multiple particulates containing nanowires dispersed in a conductive polymer network are obtained.

Air-suspension coating method: In the air suspension coating process, the graphene-infiltrated porous anode active material particles are dispersed into the supporting air stream in an encapsulating chamber. A controlled stream of a polymer-solvent solution (e.g. polymer or its monomer or oligomer dissolved in a solvent; or its monomer or oligomer alone in a liquid state) is concurrently introduced into this chamber, allowing the solution to hit and coat the suspended particles. These suspended graphene-infiltrated porous anode active material particles are encapsulated (fully coated) with or dispersed in a polymer or reactive precursor (monomer, oligomer, etc. which is polymerized/cured concurrently or subsequently) while the volatile solvent is removed. This process may be repeated several times until the required parameters, such as full-coating thickness (i.e. encapsulating shell or wall thickness), are achieved. The air stream which supports the anode particles also helps to dry them, and the rate of drying is directly proportional to the temperature of the air stream, which can be adjusted for optimized shell thickness.

In a preferred mode, the graphene-infiltrated porous anode active material particles in the encapsulating zone portion may be subjected to re-circulation for repeated coating. Preferably, the encapsulating chamber is arranged such that the porous particles pass upwards through the encapsulating zone, then are dispersed into slower moving air and sink back to the base of the encapsulating chamber, enabling repeated passes of the particles through the encapsulating zone until the desired encapsulating shell thickness is achieved.

Centrifugal extrusion: graphene-infiltrated porous anode active material particles may be encapsulated with a polymer or precursor material using a rotating extrusion head containing concentric nozzles. In this process, a stream of core fluid (slurry containing graphene-infiltrated porous anode active material particles dispersed in a solvent) is surrounded by a sheath of shell solution or melt containing the polymer or precursor. As the device rotates and the stream moves through the air it breaks, due to Rayleigh instability, into droplets of core, each coated with the shell solution. While the droplets are in flight, the molten shell may be hardened or the solvent may be evaporated from the shell solution. If needed, the capsules can be hardened after formation by catching them in a hardening bath. Since the drops are formed by the breakup of a liquid stream, the process is only suitable for liquid or slurry. A high production rate can be achieved. Up to 22.5 kg of microcapsules can be produced per nozzle per hour and extrusion heads containing 16 nozzles are readily available.

Vibrational nozzle encapsulation method: Core-shell encapsulation or matrix-encapsulation of graphene-infiltrated porous anode active material particles can be conducted using a laminar flow through a nozzle and vibration of the nozzle or the liquid. The vibration has to be done in resonance with the Rayleigh instability, leading to very uniform droplets. The liquid can consist of any liquids with limited viscosities (1-50,000 mPa·s): emulsions, suspensions or slurry containing the graphene-infiltrated porous anode active material particles and the polymer or precursor. The solidification can be done according to the used gelation system with an internal gelation.

Spray-drying: Spray drying may be used to encapsulate graphene-infiltrated porous anode active material particles when the particles are suspended in a melt or polymer/precursor solution to form a suspension. In spray drying, the liquid feed (solution or suspension) is atomized to form droplets which, upon contacts with hot gas, allow solvent to get vaporized and thin polymer shell or matrix to fully embrace the particles. If pre-made graphene sheets (or other conductive fillers, such as carbon nanotubes, carbon nano-fibers, carbon black, etc.) are included in the suspension, the micro-droplets formed may contain graphene sheets or these conductive fillers, along with graphene-infiltrated porous anode active material particles, in the matrix of the composite particulates.

In-situ polymerization: In some micro-encapsulation processes, graphene-infiltrated porous anode active material particles are fully coated with a monomer or oligomer first. Then, direct polymerization of the monomer or oligomer is carried out on the surfaces of these nanowires.

Matrix polymerization: This method involves dispersing and embedding graphene-infiltrated porous anode active material particles in a polymeric matrix during formation of the particulates. This can be accomplished via spray-drying, in which the particulates are formed by evaporation of the solvent from the matrix material. Another possible route is the notion that the solidification of the matrix is caused by a chemical change.

Encapsulation of graphene-infiltrated porous anode active material particles typically leads to further improvement in charge-discharge cycling stability.

The following examples serve to provide the best modes of practice for the present disclosure and should not be construed as limiting the scope of the disclosure:

### Example 1: Production of Porous Si Particles from Si—Al Alloys

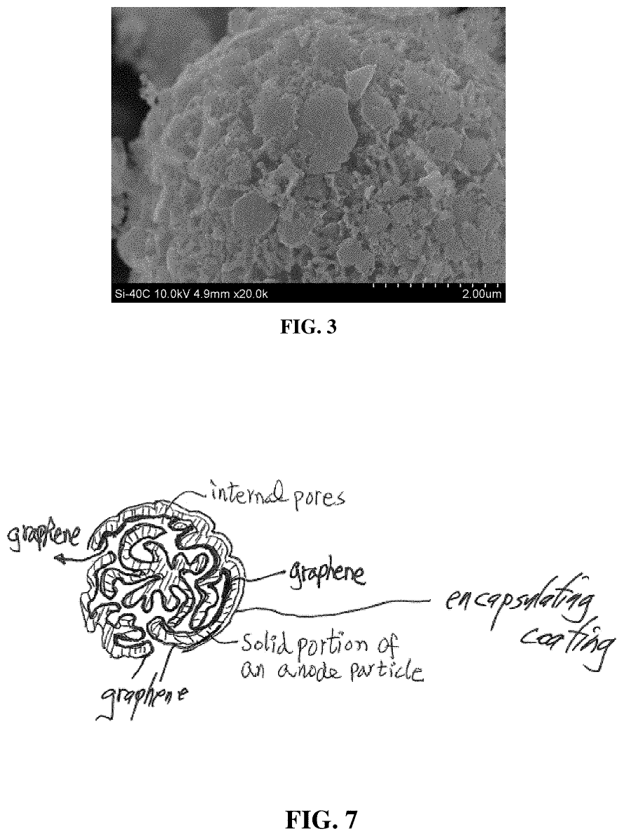

Two types of Si—Al alloys were used as the starting materials; one containing 30% by weight of Si (70% Al) and the other 20% by weight of 20% (80% of Al). The production of porous Si particles was then conducted by etching particles of these Si—Al alloys separately using HCl solution at room temperature for 24 hours. The Al element was removed from the structure, leaving behind pores in a Si structure (e.g. as shown in an SEM image of FIG. 3).

Some amount of porous Si was then infiltrated with a graphene material according to the above disclosed method and some details are given in Example 4.

### Example 2: Production of Porous SnO₂ Nano Particles

Porous SnO₂ nano particles were synthesized by a modified procedure described by Gurunathan et al [ACS Appl. Mater. Inter., 6 (2014) 16556-16564]. In a typical synthesis procedure, 8.00 g of SnCl₂.6H₂O, 5.20 g of resorcinol and 16.0 mL of 37% formaldehyde solution were mixed in 160 mL of H₂O for about 30 minutes. Subsequently, the solution is sealed in a 250 mL round-bottom flask and kept in water bath at 80° C. for 4 hours. The resulting red gel is dried at 80° C. in an oven and calcined at 700° C. for 4 hours in N₂ and air atmosphere in sequence. Finally, the obtained white SnO₂ were mechanically ground into finer powder for 30-60 minutes in mortar.

### Example 3: Production of Porous Si Through Reduction of SiO₂

Porous Si can be produced from a mixture of a silica source material, magnesium and/or aluminum powder as a reducing agent, and a salt or mixture of salts as a heat absorbent. The procedure is well-known in the art. For instance, KCl (having a melting temperature of 771° C.) was used as the heat absorbent in one of the procedures used. In a typical procedure, 0.5 g of nano-SiO₂ power (15-20 nm in diameter) was dispersed in an aqueous KCl solution (0.1 g/mL) under stirring at room temperature. The weight ratio of silica to KCl was 30:70. The mixture was heated to 80° C. under vigorous stirring followed by drying under vacuum at 90° C. to remove water. Dried nano-SiO₂/KCl powder was then homogenized by hand-milling in an agate mortar.

A mixture of above nano-SiO₂/KCl powder and magnesium powder (100-200 mesh) was ground together in the agate mortar at a molar ratio of Mg/SiO₂=2.0. Subsequently, the obtained mixture was loaded in a zirconia boat and placed in the constant temperature zone of a tube furnace. The furnace was heated from room temperature to 650° C. at a rate of 2′C/min and kept at 650° C. for 4 hours under an mixed atmosphere of Ar (95 vol. %)/H₂ (5 vol. %). Finally, after cooling to room temperature, a uniform powder in yellow color was obtained. The obtained product after magnesiothermic reduction was immersed in water and filtered, where KCl can be recycled by drying the filtrate. The residue was immersed into 2 M HQ solution and stirred for 12 hours to remove MgO. To further remove small amount of unreacted and surface-grown SiO₂, 1 wt. % HF/EtOH (10 vol. %) solution was used and stirred for 15 min. Finally, silicon products were washed with distilled water and ethanol until pH=7 and then vacuum dried at 60° C. for 10 hours.

Some amount of porous Si was then infiltrated with a graphene material according to the above disclosed method and some details are given in Example 6.

### Example 4: Graphene from Naphthalene and Chlorinated Naphthalene

Graphene-infiltrated porous Si particles were produced from heat treated naphthalene and chlorinated naphthalene (2,3,6,7-Tetrachloronaphthalene) molecules inside internal pores by executing the following procedure (as an example): (a) pouring a mass of 20 g of porous Si particles, chlorinated naphthalene (1 g), chlorophenylene (1 g), 0.02 g of PdCl₂ catalyst and a liquid solvent into a stainless steel reactor (10 gallon size); (b) heating the reactor from 25° C. to 150° C. at a rate of 2 degrees per minute and subsequently maintaining the temperature at 150° C. for 4 hours to obtain suspension of larger polycyclic aromatic molecules; (c) vaporizing the liquid component of the suspension to obtain a sample of dried powder containing polycyclic aromatic molecules deposited on internal pore surfaces and external surfaces; (d) heat-treating the sample at a temperature of 800° C. for 2 hours to obtain dark-color coating inside the pores and on the external surfaces. The dark-color coating or films were determined by TEM and Raman spectrometer to be single-layer and few layer graphene. In contrast, without the catalyst, the temperature for incipient formation of graphene inside the internal pores is typically from 900 to 1,100° C. given the same chlorinated naphthalene or naphthalene.

### Example 5: Functionalized Graphene from Anthracene and Halogenated Anthracene

A mixture of porous SnO₂ (100 g) and a mass (10 grams) of anthracene or brominated anthracene, respectively, was added into a stainless steel reactor, which was heated from 25° C. to a temperature of 145° C. and subsequently maintained at the same temperature for 3 hours. On a separate basis for each starting material, 2′-chloro-1,1′:4′,1″-terphenyl was added into a stainless steel reactor, which was heated from 25° C. to a temperature of 145° C. and subsequently maintained at the same temperature for 12 hours in the presence of a catalyst, PdCl₂. Both procedures led to the formation of larger polycyclic hydrocarbons inside internal pores of porous SnO₂ particles.

Subsequently, diethylenetriamine (DETA) was added separately into both reactors and the material mixture was processed at 350° C. for an additional 2 hours to obtain amine-functionalized aromatic carbon planes well dispersed in a disordered matrix of hydrocarbon molecules and solvent. Such a suspension was cooled down to below 100° C. The infiltrated particles were dried and then subjected to a heat treatment temperature at 1,200° C. for 2 hours to obtain graphene coating on pore wall surfaces.

In separate experiments, the following functional group-containing species were separately introduced to the aromatic mass being heat-treated at up to 350° C.: an amino acid, sulfonate group (—SO₃H), 2-Azidoethanol, polyamide (caprolactam), and aldehydic group. In general, these functional groups were found to promote or facilitate edge-to-edge chemical merging between aromatic molecules that grow into larger and fewer-layer graphene. The final heat treatment temperature was typically from 800 to 1,500° C.

### Example 6: Graphene from Other Polycyclic Aromatic Hydrocarbon Molecules

Various PAHs were used as a starting material for producing graphitic films through the presently disclosed method. The representative processing conditions are summarized in Table 1 below:

TABLE 1
Representative processing conditions and some
salient features of products (Cl- means chlorinated;
Br- means brominated; F- means fluorinated.

| Sample | Aromatic | 1^{st} heat treatment and | 2^{nd} heat |
|---|---|---|---|
| ID | molecules | catalyst (if any) | treatment |
| Ph-1 | Chlorinated | 150° C. 2 h (PdC1₂) + | 600° C., 3 h |
| | Phenanthrene | 300° C. 3 h | |
| Ph-2 | Phenanthrene | 150° C. 2 h (PdC1₂) + | 1,500° C. |
| | | 300° C. 3 h | |
| Ph-3 | Chlorinated | 150° C. 2 h + | 1,200° C., 3 h |
| | Phenanthrene | 30300° C. 3 h | |
| Tc-1 | Tetracene | 125° C. 2 h (FeCl₃) + | 900° C., 3 h |
| | | 300° C. 3 h | |
| Tc-2 | Br-Tetracene | 125° C. 2 h + | 900° C. 1 h |
| | | 300° C. 3 h | |
| Py-1 | Pyrene | 150° C. 5 h (PdCl₂) + | 1500° C., 3 h |
| | | functionalization | |
| Py-2 | Cl-Pyrene | 150° C. 3 h (PdC1₂) | 900° C., 3 h |
| Cn-1 | Coronene | 350° C. 3 h | 1100° C. 2 h |
| Cn-2 | Cl-Coronene | 350° C. 3 h | 1500° C. 2 h |
| PP-1 | Petroleum pitch | 300° C. 2 h + | 2500° C. 1 h |
| | | 1500° C. 2 h | |
| PP-2 | Br-Petroleum pitch | 300° C. 2 h | 1250° C. 3 h |
| CP-1 | Coal tar pitch | 350° C. 2 h (FeCl₃) | 900° C. 3 h |
| CP-2 | Cl-Coal tar pitch | 950° C. 2 h (FeCl₃) | None |
| CP-3 | Coal tar pitch | 1200° C. 2 h | None |
| Tp + | Cl-triphenylene + | 300° C. 2 h | 1,500° C. 2 h |
| An-1 | F-anthracene | | |
| Tp-An- | Cr-triphenylene + | 300° C. 2 h | 2450° C. 2 h |
| 2 | F-anthracene | | |

These data indicate that, upon completion of the first heat treatment, the longer/wider aromatic molecules can be further increased in length and width if the material is subjected to a second heat treatment at a higher temperature. Halogenation, along with some catalyst, can promote ring-fusing of polycyclic aromatic molecules, at a lower temperature as compared with the cases where no catalyst, to form larger aromatic molecules that are essentially incipient graphene molecules.

All the PAHs herein investigated (e.g. halogenated and un-halogenated versions of naphthalene, anthracene, phenanthrene, tetracene, chrysene, triphenylene, pyrene, pentacene, benzo-pyrene, corannulene, benzo-perylene, coronene, ovalene, and benzo-fluorene) can be methylated, aminated (derivatized with amine), hydroxylated, etc. to obtain derivatives having a substituent on a ring structure thereof. All the derivatives of these PAHs can be used as a starting material for practicing instant disclosed process to produce single-layer or few-layer graphene coating.

As an example of the derivative of a PAH, chemical oxidation of anthracene occurs readily in the presence of, for example, hydrogen peroxide and vanadyl acetylacetonate, giving anthraquinone, C₁₄H₈O₂, shown below:

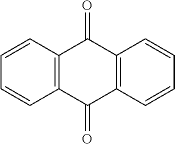 [SMILES: O=C1c2ccccc2C(=O)c2ccccc21]

These two O atoms are highly active and can readily react with a broad array of chemical species, such as those selected from —SO₃H, —COOH, —NH₂, —OH, —R′CHOH, —CHO, —CN, —COCl, halide, —COSH, —SH, —COOR′, —SR′, —SiR′₃, Si(—OR′—)_{y}R′₃-y, Si(—O—SiR′₂—)OR′, R″, Li, AlR′₂, Hg—X, TlZ₂ and Mg—X; wherein y is an integer equal to or less than 3, R′ is hydrogen, alkyl, aryl, cycloalkyl, or aralkyl, cycloaryl, or poly(alkylether), R″ is fluoroalkyl, fluoroaryl, fluorocycloalkyl, fluoroaralkyl or cycloaryl, X is halide, and Z is carboxylate or trifluoroacetate. Essentially, all the derivatives of PAHs can be used as a starting material for the production of graphene inside the internal pores and on exterior surfaces of porous particles.

### Example 7: Preparation and Electrochemical Testing of Various Battery Cells

For most of the anode and cathode active materials investigated, we prepared lithium-ion cells or lithium metal cells using the conventional slurry coating method. A typical anode composition includes 85 wt. % active material (e.g., graphene-infiltrated Si, SiO, and SnO₂ particles), 7 wt. % acetylene black (Super-P), and 8 wt. % polyvinylidene fluoride binder (PVDF, 5 wt. % solid content) dissolved in N-methyl-2-pyrrolidinoe (NMP). After coating the slurries on Cu foil, the electrodes were dried at 120° C. in vacuum for 2 h to remove the solvent. For full-cell testing, cathode layers are made in a similar manner (using Al foil as the cathode current collector) using the conventional slurry coating and drying procedures. Cathode active materials studied include the well-known NCM, NCA, and LFP. An anode layer, separator layer (e.g. Celgard 2400 membrane), and a cathode layer are then laminated together and housed in a plastic-Al envelop. The cell is then injected with 1 M LiPF₆ electrolyte solution dissolved in a mixture of ethylene carbonate (EC) and diethyl carbonate (DEC) (EC-DEC, 1:1 v/v). In some cells, ionic liquids were used as the liquid electrolyte. The cell assemblies were made in an argon-filled glove-box.

The cyclic voltammetry (CV) measurements were carried out using an Arbin electrochemical workstation at a typical scanning rate of 1-10 mV/s. In addition, the electrochemical performances of various cells were also evaluated by galvanostatic charge/discharge cycling at a current density of from 50 mA/g to 10 A/g. For long-term cycling tests, multi-channel battery testers manufactured by LAND were used.

In lithium-ion battery industry, it is a common practice to define the cycle life of a battery as the number of charge-discharge cycles that the battery suffers 20% decay in capacity based on the initial capacity measured after the required electrochemical formation.

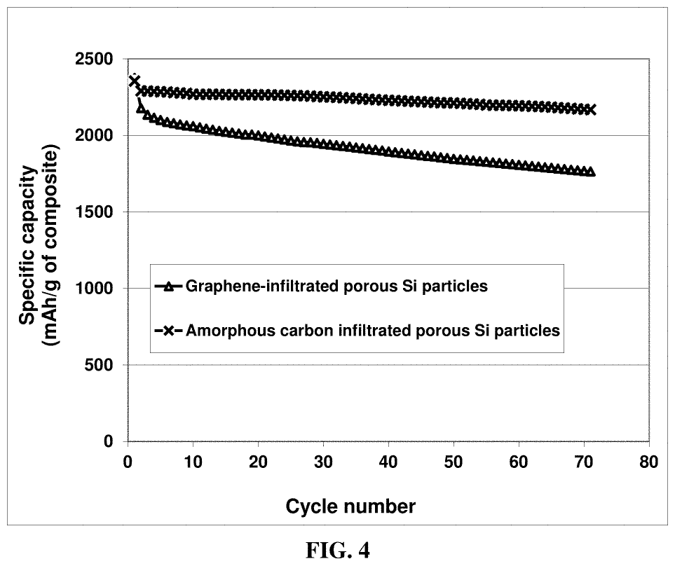

FIG. 4 shows the charge-discharge cycling behaviors of 2 lithium cells featuring porous Si particle-based anodes: one cell containing graphene-infiltrated porous Si particles and the other cell featuring porous Si anode materials particles with amorphous carbon infiltration. It is clear that the presently invented graphene-infiltrated porous Si particles exhibit significantly more stable battery cycle behavior. A control cell having an anode containing the same type of porous Si particles but without carbon or graphene infiltration was also tested. This control cell showed a low first-cycle efficiency (63.2%), in contrast to the 88.5% first-cycle efficiency of the cell featuring graphene-infiltrated porous Si particles.

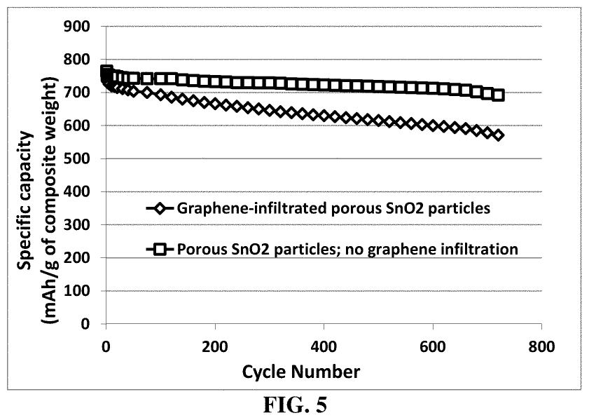

Shown in FIG. 5 are the charge-discharge cycling behaviors (specific capacity) of 2 lithium-ion cells each having porous SnO₂ particles as the an anode active material: one cell featuring graphene-infiltrated and conducting PANi-encapsulated porous SnO₂ particles; the other cell having PANi-encapsulated porous SnO₂ particles but no graphene infiltration. The presently invented strategy of implementing a graphene material into internal pores of anode particles imparts a much stable cycle life to a lithium-ion battery.

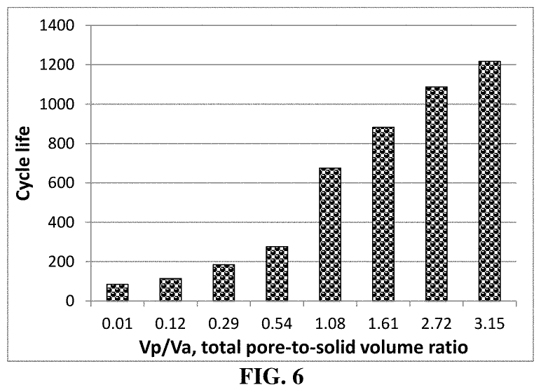

The effects of the pore-to-solid anode active material volume ratio in the invented particles may be illustrated in FIG. 6, which shows the cycle life of a lithium-ion cell containing graphene-infiltrated porous Si particles, plotted as a function of the pore-to-solid volume ratio in the particles. These data have demonstrated the significance of the pore volume in impacting the cycle life of a lithium-ion battery. Typically, there is a threshold total pore volume-to-total solid volume ratio above which a dramatic increase in cycle life is observed.

1. An anode active material particle for a lithium battery, said particle comprising internal pores, having a pore volume of Vp and pore wall surfaces, and a solid portion having a solid volume Va, wherein the volume ratio Vp/Va is from 0.1/1.0 to 10/1.0 and wherein the pores, having pore sizes from 2 nm to 10 μm, are infiltrated with a graphene material that partially or fully covers the internal pore wall surfaces.

2. The particle of claim 1, wherein an external surface of the particle is further covered with a graphene material.

3. The particle of claim 1, wherein the graphene material comprises 1-10 graphene planes stacked together.

4. The particle of claim 1, wherein the particle has a specific surface area from 5 to 1000 m²/g prior to being infiltrated with the graphene material.

5. The particle of claim 1, wherein at least half of the internal pore wall surfaces are covered with the graphene material.

6. The particle of claim 1, wherein said anode active material is selected from the group consisting of: (a) silicon (Si), germanium (Ge), tin (Sn), phosphorus (P), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, P, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, Nb, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide; (f) prelithiated versions thereof; and (g) combinations thereof.

7. The anode particulate of claim 1, wherein said anode active material contains a prelithiated Si, prelithiated Ge, prelithiated Sn, prelithiated P, prelithiated SnOₓ, prelithiated SiOₓ, prelithiated iron oxide, prelithiated VO₂, prelithiated Co₃O₄, prelithiated Ni₃O₄, lithium titanate, lithium titanium-niobium oxide (TNO), or a combination thereof, wherein x=1 to 2.

8. The particle of claim 1, wherein said anode active material is in a form of nano particle, nano wire, nano fiber, nano tube, nano sheet, nano belt, nano ribbon, nano disc, nano platelet, or nano horn having a thickness or diameter from 0.5 nm to 100 nm.

9. The particle of claim 1, further comprising a shell or coating of an electronically conducting polymer or lithium ion-conducting polymer that partially or completely encapsulates the particle.

10. The particle of claim 9, wherein the conducting polymer comprises a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a network or cross-linked version thereof, a copolymer thereof, a sulfonated version thereof, or a combination thereof.

11. The particle of claim 9, wherein the lithium ion-conducting polymer comprises an ionically conducting polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, a gel network version thereof, or a combination thereof.

12. A mass of anode particles containing the anode particle of claim 1.

13. A battery anode containing said particle or multiple particles of claim 1.

14. A battery containing the battery anode of claim 13.

15. The battery of claim 14, wherein said battery is a lithium-ion battery, lithium metal secondary battery, lithium-sulfur battery, lithium-air battery, or lithium-selenium battery.

16. A method of producing multiple particles of claim 1, said method comprising:
A) Providing multiple porous particles of an anode active material, wherein the particles have internal pores and pore wall surfaces;
B) impregnating the internal pores either with a suspension or solution containing aromatic molecules dispersed or dissolved in a liquid medium or with the aromatic molecules in a liquid form without the liquid medium, wherein the aromatic molecules are selected from petroleum heavy oil or pitch, coal tar pitch, a polynuclear hydrocarbon, a halogenated variant thereof, or a combination thereof and wherein said aromatic molecules, containing a plane of hexagonal carbon atoms or fused aromatic rings, have an initial length or width from 5 nm to 1 μm;
C) partially or completely removing said liquid medium, if present, allowing the aromatic molecules to stay in the internal pores; and
D) heat treating said aromatic molecules in said internal pores at a first temperature selected from 120° C. to 2,500° C. for a desired period of time to enable the aromatic molecules to be merged or fused into larger aromatic molecules, larger than said initial length or width, to form a graphene material having graphene planes on the pore wall surfaces.

17. The method of claim 16, wherein the first temperature is from 500° C. to 1,500° C.

18. The method of claim 16, wherein said method further comprises a step of heat-treating the particles at a second temperature higher than the first temperature.

19. The method of claim 16, wherein step (b) further comprises depositing the aromatic molecules on an external surface of the particles and step (d) comprises heat treating said aromatic molecules on the external surface at said first temperature so that said aromatic molecules are merged or fused into larger aromatic molecules to form graphene planes deposited on the external surface.

20. The method of claim 16, wherein said polynuclear hydrocarbon is selected from naphthalene, anthracene, phenanthrene, tetracene, chrysene, triphenylene, pyrene, pentacene, benzo-pyrene, corannulene, benzo-perylene, coronene, ovalene, benzo-fluorene, perylene, porphyrine, phthalocycnine, a derivative thereof having a substituent on a ring structure thereof, a chemical derivative thereof, or a combination thereof.

21. The method of claim 16, wherein said liquid medium contains a non-aqueous solvent selected from polyethylene glycol, ethylene glycol, propylene glycol, an alcohol, a sugar alcohol, a polyglycerol, a glycol ether, an amine based solvent, an amide based solvent, an alkylene carbonate, an organic acid, or an inorganic acid.

22. The method of claim 16, wherein said suspension or solution in step (a) further comprises a catalyst that contains a transition metal selected from Ti, V, Cr, Mn, Fe, Co, Ni, Cu, Zn, Zr, Nb, Mo, Ru, Pd, Ag, Cd, Pt, Au, a combination thereof, or wherein said catalyst contains a chemical species selected from PdCl₂, FeCl₃, FeBr₃, FeF₃, NiBr₂, NiI₂, Cs₂CO₃, CsF, CsCl, CsBr, CH₂CL₂, or a combination thereof.

23. The method of claim 16, wherein the internal pores of the particles are infiltrated, impregnated or deposited with a catalyst that contains a transition metal selected from Ti, V, Cr, Mn, Fe, Co, Ni, Cu, Zn, Zr, Nb, Mo, Ru, Pd, Ag, Cd, Pt, Au or a chemical species selected from PdCl₂, FeCl₃, FeBr₃, FeF₃, NiBr₂, NiI₂, Cs₂CO₃, CsF, CsCl, CsBr, CH₂CL₂, or a combination thereof.

24. The method of claim 16, further comprising a step of incorporating said multiple particles into a battery anode electrode.

25. The method of claim 16, wherein said particles of anode active material contain pre-lithiated particles having 0.1% to 54.7% by weight of lithium ions preloaded into said particles prior to step (a) of mixing.

26. The method of claim 16, wherein further comprising a step of coating said multiple particles with an electron-conducting or lithium ion-conducting material after step (d).

27. The method of claim 26, the electron-conducting material comprises a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

28. The method of claim 26, the lithium ion-conducting material comprises an ionically conducting polymer gel network comprising a polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof.

29. The method of claim 16, wherein said particles of anode active material are selected from the group consisting of: (a) silicon (Si), germanium (Ge), tin (Sn), phosphorus (P), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, P, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, Nb, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide; (f) prelithiated versions thereof; and (g) combinations thereof.

30. The method of claim 16, wherein said anode active material particles are in a form of flakes, beads, pellets, spheres, wires, fibers, filaments, discs, ribbons, or rods, having a diameter or thickness from 2 nm to 20 μm.
